(19) United States
(12) Patent Application Publication
(10) Pub. No.: US 2008/0155042 A1
(43) Pub. Date: Jun. 26, 2008

(54) Method For Communication And Collaboration Over A Network

(76) Inventors: Gaby Heinle, Muenchen (DE); Florian Mugler, Tuerkenfeld (DE); Ralph Soika, Muenchen (DE)

Correspondence Address: ST. ONGE STEWARD JOHNSTON & REENS, LLC, 986 BEDFORD STREET, STAMFORD, CT, 06905-5619, US

(21) Appl. No.: 11/959,173

(22) Filed: Dec. 18, 2007

Related U.S. Application Data
(60) Provisional application No. 60/871,857, filed on Dec. 26, 2006.

(51) Int. Cl. G06F 15/16

(52) U.S. Cl. 709/206

(57) ABSTRACT

In a method for communication over a network workflow process data retrieved from a workflow server is associated with user data identifying a user of an instant messaging system and the association between user data and workflow process data is displayed on a user interface. The method allows to process workflow data within an instant messaging client.

### CROSS-REFERENCE TO RELATED APPLICATIONS

The present application claims the benefit under 35 U.S.C. §119(e) of the U.S. Provisional Patent Application Ser. No. 60/871,857, filed on Dec. 26, 2006, the content of which is incorporated herein by reference.

### FIELD OF THE INVENTION

The invention relates to a method for communication and collaboration over a network, in which workflow data provided by a workflow server are processed by an instant messaging client.

### BACKGROUND OF THE INVENTION

Such a method is known from US 2004/0054740 A1. The known method uses an instant messaging server, which is connected to a workflow server. The workflow server can generate a workflow request identifying a particular workflow participant. If the instant messaging server determines that the workflow participant is present, then the workflow request is transformed in an instant message and transmitted to an instant messaging client. The instant messaging client receives the instant message containing the workflow request and launches a workflow plug-in to process the workflow request by, for example, prompting the workflow participant for a response. If the workflow participant responds to the request, then the response is transmitted to the workflow server via the instant messaging server. The known method allows instant notification of a workflow participant once the workflow server needs the response from a workflow participant.

In most cases, however, the workflow participant wishes to trigger a workflow process by himself, which currently can only be done by leaving the instant messaging system and by starting a specific application designed for processing various steps of a workflow. For an example, an employee of a company may have received the permission of his supervisor to take a few days off while chatting with his supervisor by an instant messaging system. After the employee has received the permission for vacation the employee must fill an electronic form to apply for a leave. Typically, the electronic form is provided by an application designed for personal administration. For officially approving the employee's application for leave the supervisor must also leave the instant messaging environment and start the application for personal administration. Thus, current communication methods do not provide the opportunity to process a workflow within an instant messaging system.

Furthermore a method for associating the content of messages with additional data is known from US 2006/0088144 A1. In the known method the content of incoming messages is analyzed and additional information relating to the content of the messages is obtained by an data link engine which allows users to manage a workflow within the messaging system.

### SUMMARY OF THE INVENTION

Proceeding from this related art, the present invention is based on the object of providing an improved method for communication over a network, in which workflow and instant messaging processes are effectively combined.

This object is achieved by a method having the features of the independent claim. Advantages embodiments and refinements are specified in claims dependent thereon.

In the method user data identifying a user of the instant messaging client are associated with workflow process data supplied by the workflow server and the association between user data and workflow process data is displayed on a user interface. Thus, the user can immediately recognize the workflow issues associated with himself. In particular, if the user enters an instant messaging session with a selected other user, workflow issues can be discussed between the user and the other user. Furthermore, workflow processes can be triggered during the instant messaging session, since the workflow processes associated with the user can be displayed on the user interface. Therefore, the method creates a natural working environment, which allows a quick exchange of information as if the communication partners were sitting in front of the same terminal.

On log-in of a specific user in an instant messaging client a user identification of the specific user is preferably requested from a directory service. The specific user can then be identified by the user identification for further processes.

In a preferred embodiment, a list of workflow process data associated with the user identification is requested from the workflow server and cached in the instant messaging client. The workflow process date is preferably requested from the workflow server after the log-in of the specific user into the instant messaging client. The content of the cache can be updated periodically by repeating the request after a given time period. That way, the system load can be kept low within the network. In addition the work process data displayed on the user interface represent the actual state of the workflow process date wherein the delay can be adjusted by choosing appropriate parameters for the refreshment operation.

Furthermore, a list of other users available for instant messaging is requested from an instant messaging server and periodically updated. Thus, the specific user is provided with actual information on other users available for the exchange of instant messages. The specific user may then select one of the other users listed on the user interface. After the selection of one of the other users the specific user can be provided with process data associated with the other user and supplied by the workflow server.

A status list of workflow processes created by the specific user and assigned to the other users is preferably created from the workflow process data cached in the instant messaging client and displayed on the user interface. Therefore, the display of the workflow process data allows the user to recognize the status of the workflow processes, which he has assigned to other users.

In addition, a task list of workflow processes created by the other users and assigned to the specific user is created from the workflow process data cached in the instant messaging client and displayed on the user interface. In this case the specific user will be informed on the tasks which have to be performed by himself.

In the status list or task list the availability of the other user can be indicated by indicators associated with the items of the status list or task list. By these indicators the user can directly recognize whether a partner for a workflow process is available.

On selecting a selected user from a list of available other users, the user ID of the selected user is preferably requested from a directory service by the instant messaging client.

In a preferred embodiment a status list of workflow processes created by the specific user and assigned to the selected user is created by the instant messaging client from the workflow process data cached in the instant messaging client and displayed on the user interface. In this case, the user is able to select those workflow processes, which have been created by himself and assigned to the selected user. This, feature is especially useful for supervisors, which have assigned a great number of tasks to other users.

Furthermore, a task list of workflow processes created by the selected user and assigned to the specific user is created by the instant messaging client and displayed on the user interface. Thus, the user is able to select these workflow processes, which have been created by the selected user and assigned to the specific user. If a large number of tasks have been assigned to a specific user, the specific user can select among all workflow processes these workflow processes assigned to him by the selected user and can enter into an instant messaging session to discuss the workflow processes with the selected user.

In a preferred embodiment, the selection of an item in the status list or task list causes a workflow form to open, which may be used for processing a workflow step. If data has to be entered in the workflow form, the data can be transmitted to the workflow server for further processing. Therefore, the method allows a complete handling of the workflow processes provided by the workflow server.

In another preferred embodiment the workflow server comprises a web service interface so that the workflow server can even be reached over a worldwide area data network as the internet.

### BRIEF DESCRIPTION OF THE DRAWINGS

Further advantages and properties of the present invention are disclosed in the following description, in which exemplary embodiments of the present invention are explained in detail on the basis of the drawing.

FIG. 1 shows instant messaging clients, connected to a workflow server and an instant messaging server via a data network;

FIG. 2 shows the architecture of an instant messaging client, connected to an instant messaging server and a workflow server;

FIG. 3 shows a flow diagram of a method for operating an instant messaging client;

FIG. 4 shows a possible user interface, in which a number of available instant messaging users and a worklist are displayed;

FIG. 5 is a user interface, in which available instant messaging user and a status list is displayed;

FIG. 6 shows the user interface, according to FIG. 5 with the status list expanded;

FIG. 7 shows the user interface, according to FIG. 6 after the selection of one of the available instant messaging users;

FIG. 8 shows the user interface after the selection of one workflow process in the status list;

FIG. 9 shows another possible form, which might be opened after the selection of one item in the status list; and

FIG. 10 shows a form, which opens if a new workflow process is created.

### DETAILED DESCRIPTION OF THE INVENTION

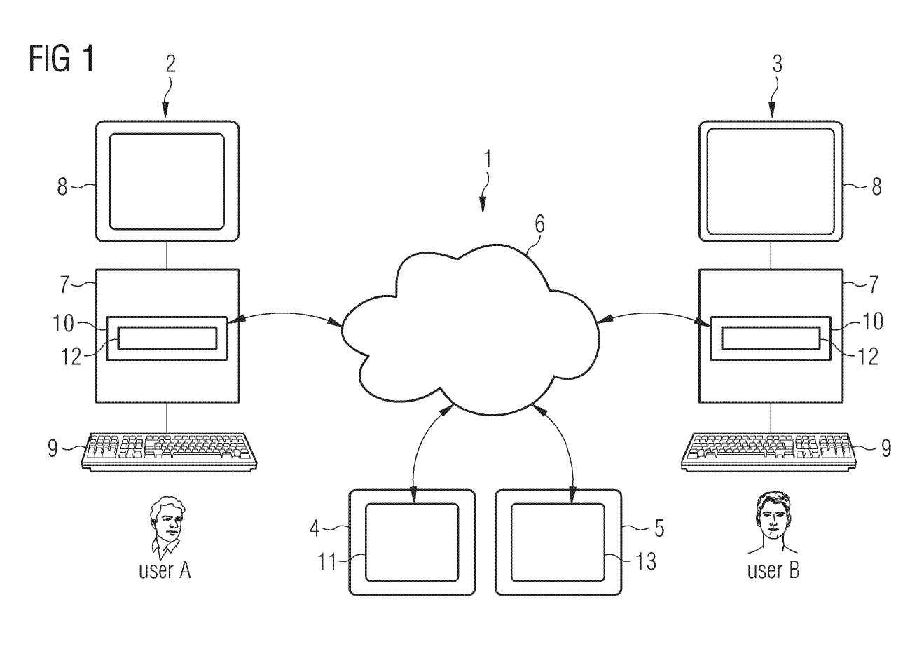

FIG. 1 is a block diagram, showing a client-server environment 1, having clients 2 and 3, which are connected to server 4 and 5 via a data network 6. The clients 2 or 3 may be workstations or mobile devices as, for example, a mobile phone or personal digital assistants (PDAs). The connection between the clients 2 or 3 and the server 4 and 5 may be established over a network 6, for instance a local area network or a medium or wide area network. The transmission of data may furthermore be performed by any medium. Besides the transmission of data over wires also wireless communication has to be considered.

If the clients 2 or 3 are personal computers, the clients 2 and 3 may comprise computers 7, which are provided with monitors 8 and keyboards 9 or any other input advice not shown in FIG. 1. Furthermore, the computers 7 are provided with computing means for running an instant messaging client 10, which exchanges data with an instant messaging server 11, which runs for example, on server 4. The instant messaging client 10 includes a workflow plug-in 12, which allows the instant messaging client 10 to communicate with a workflow server 13 residing for instance on server 5.

It should be noted, that the instant messaging server 11 and the workflow server 13 may also run on the same physical or virtual machine or may each be distributed over a number of physical devices or virtual devices.

In FIG. 1 finally shows a user A and a user B who are using the clients 2 and 3 for exchanging instant messages and for collaborating on shared workflow processes.

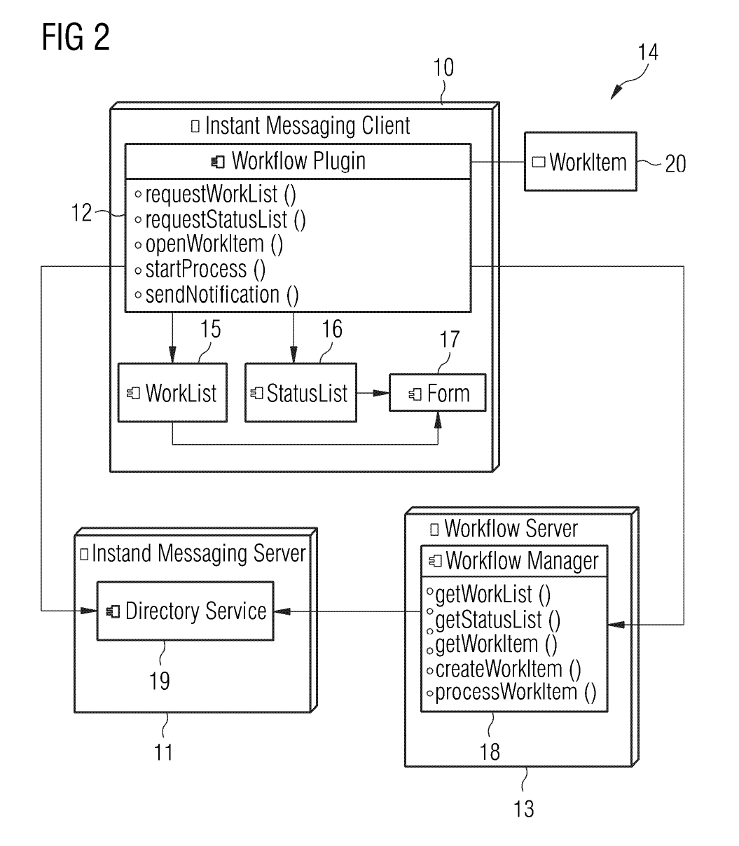

FIG. 2 shows details of a software architecture for an instant messaging software 14 designed for messaging and collaboration purposes in the client-server environment 1 of FIG. 1. As already mentioned, the instant messaging client 10 includes the workflow plug-in 12. In FIG. 2 the workflow plug-in 12 is shown to include a number of methods, which have been implemented to extend the functionality of the instant messaging client 10.

For example, the method requestWorkList( ) can be used to retrieve a so called worklist 15, or a method like requestStatusList( ) can be used to create a status list 16 both of which may be displayed within an instant messaging form 17. The worklist 15 and the status list 16 may be stored within a cache administrated by the instant messaging client 10.

Each time a new item for the worklist 15 or the status list 16 is available on the workflow server 13 a method sendNotification( ) may be called to notify the user of the instant messaging client 10 that a new item is available and that the content of the worklist 15 or the status list 16 has been updated.

Further methods like openWorkitem( ) and startProcess( ) are provided to display details on work items listed in the worklist 15 or in the status list 16 or to start a work process listed in the worklist 15.

On executing one of these methods the workflow plug-in 11 connects to a workflow manager 18 within the workflow server 13. The workflow manager 18 provides methods to process the request from the workflow plug-in 12.

For instance, the method getWorkList( ) retrieves a number of data sets from a data base, depending on the parameter transmitted from the workflow plug-in 12. In particular, the method getWorkList( ) searches for work processes, which are associated with the user identification of a user who has logged in into the instant messaging client 10.

For notification and authorisation purposes the workflow manager 18 can also contact a directory service 19 in which user identifications are administrated. In FIG. 2 the directory service 19 is hosted by the instant messaging server 11 and provides the user identification of users, which are known within the client-server environment 1. The workflow plug-in 12 can also connect directly to the directory service 19 for getting the user identification of a user, which has logged into the instant messaging client 10 so that correct user data are transmitted to workflow manager 18.

Similarly, the invocation of requestStatusList( ) within the workflow plugin results in executing method getStatusList( ) within workflow manager 18. In this case, data sets describing the status of a work process are searched in a data base and returned to workflow plug-in 12.

Finally, the method openWorkitem( ) in workflow plug-in 12 corresponds to method getworkitem( ) within workflow manager 18. Both methods may be used to display details on a work item selected in the worklist 15 or the status list 16. Typically, the details on a work process are displayed in a work item form 20.

The invocation of the method startProcess( ) within workflow plug-in 12 can also result in the opening of the work item form 20 if the results of the processing have to be displayed in a form. It should be noted, that the method startProcess( ) in workflow plug-in 12 corresponds to the method processWorkitem( ) in workflow manager 18.

Finally, the method createWorkitem( ) in workflow manager 18 is involved if a new work item should be created in the data base administrated by the workflow manager 18. The creation of a new work item may also be associated with the display of work item form 20.

The instant messaging client 10 and the workflow plugin 12 form the presentation layer. These components comprise methods for the graphical user interface (=GUI), in particular methods for the display of the workflow process data. In contrast to the instant messaging client 10 and the workflow plugin 12, the workflow server 13 is provided with backend methods implementing the business logic which is independent from the presentation layer. The workflow plugin 12 uses the methods provided by the workflow server 13 to achieve an appropriate presentation for the user.

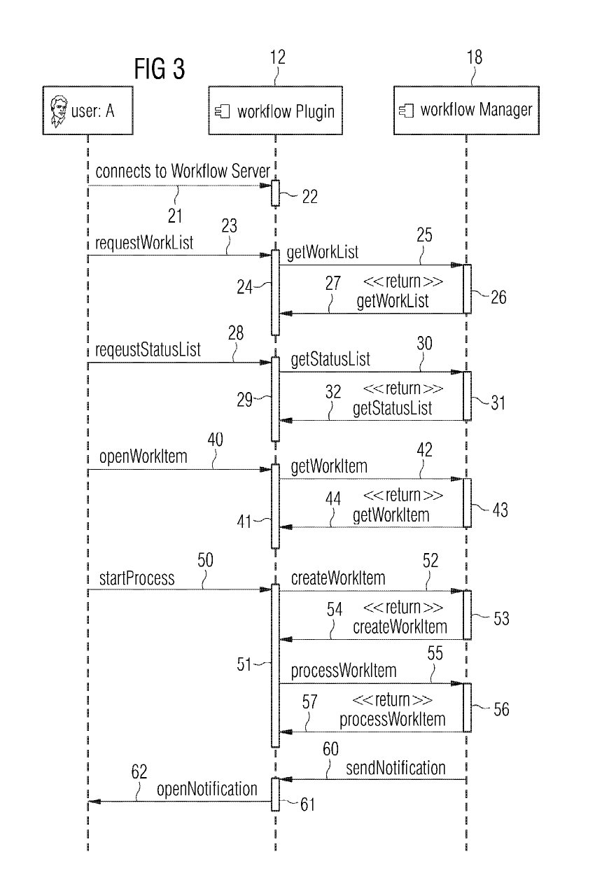

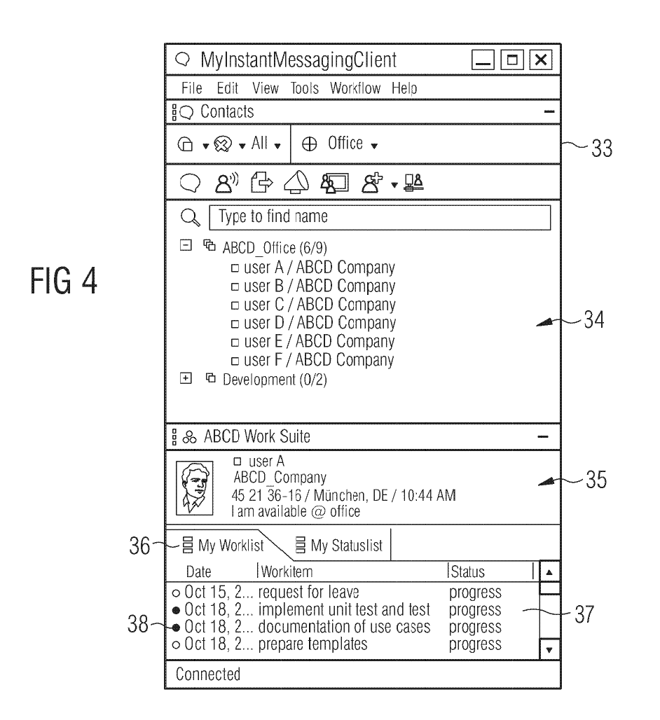

In the following the functionality of the instant messaging software 14 will be described in more details referring to FIG. 3 and the forms depicted in FIG. 4 to 10.

FIG. 3 shows the interaction between a user, for instance user A, the workflow plug-in 12 and the workflow manager 18. If user A issues a connection instruction 21 a connection process 22 is started, which connects the workflow plug-in 12 to workflow server 13. Subsequently, if the workflow plug-in 12 receives a worklist invocation 23, a worklist process 24 is started, which sends a worklist request 25 to workflow manager 18, which results in a worklist process 26. The worklist process 26, which runs on workflow server 13, returns a worklist response 27 to worklist process 24.

Equally, if workflow plug-in 12 receives a status list invocation 28 a status list process 29 is started. The status list process 29 sends a status list request 30 to workflow manager 18, which starts the status list process 31. Before terminating the status list process 31 returns a status list response 32.

These operations may result in an instant messaging form 33, as shown in FIG. 4. The instant messaging form 33 is an example for the instant messaging form 17 of FIG. 1. The instant messaging form 33 may be displayed on the monitor 8 of client 2 or client 3. The instant messaging form 33 of FIG. 4 is divided into two sections. The upper section of instant messaging form 33 is a contact form 34, whereas the lower part of instant messaging form 33 contains a workflow form 35.

Among other things, the contact form 34 displays these users, which are available for instant messaging. These are those users who are currently logged in into one of the instant messaging clients 10 of the client-server environment 1.

For instance, in FIG. 4 a list of available users beginning with user A and ending with user F are available in the office of the ABCD company. The contact form 34 allows starting an instant messaging session between any one of the available users. For these purposes the contact form 34 is provided with a number of button and menus well known in the art. Therefore a detailed description of the instant messaging functionality within the contact form 34 has been omitted.

In the lower section of instant messaging form 33, the workflow form 35, a worklist 36 is displayed containing a number of work items 37. The work items 37 represent work processes created by other users than user A but delegated to user A. The worklist 36 may also include indicators 38 indicating whether the user, who has created the associated work item 37, is available for instant messaging. For example, if user B has created the first work item in the worklist 36 and if according to FIG. 4 user B is available for instant messaging, the indicator 38 in front of the work process “request for leave” indicates that user B is available for instant messaging. If user A wants to send user B a message regarding user B's request for a leave user A may contact user B immediately. After the exchange of instant messages user A may finally process the request for leave by allowing or denying user B's request.

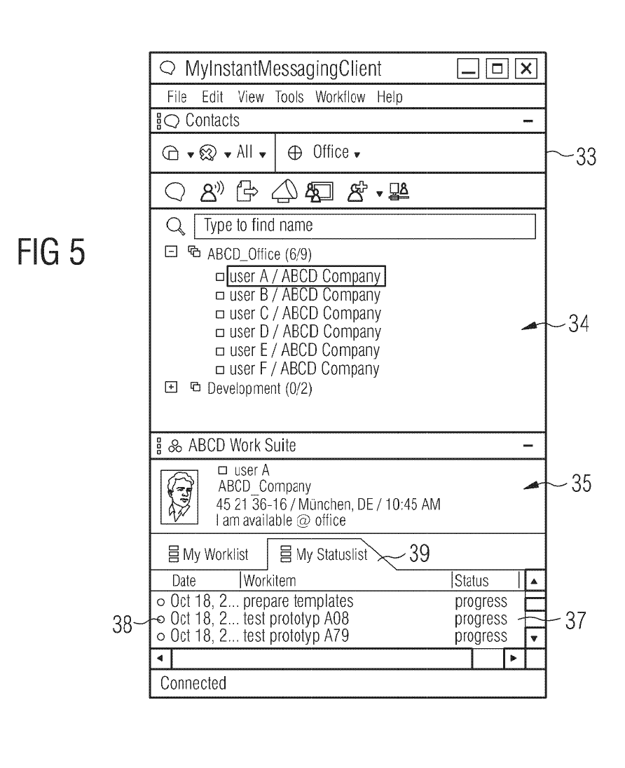

The workflow form 35 according to FIG. 4 contains also a tab, which refers to a status list 39 containing work items 37 which have been created by user A and delegated to any other user. The status list is shown in more detail in FIG. 5. As in FIG. 4 indicators 38 associated with the work items 37 indicate whether the user to whom the work item has been delegated is available for instant messaging.

The worklist 36 and the status list 37 are invoked on opening of the workflow form 35 or by clicking on one of the tabs associated with the worklist 36 or the status list 37. If the worklist 36 is invoked by clicking on the tab of the worklist the worklist process 24 is started, which results in displaying the worklist 36 within the instant messaging form 33.

If the worklist 36 is invoked by clicking on the associated tab, the worklist 36 is generated on the basis of data which is either received by the worklist process 24 of FIG. 3 or by a periodical refreshment process which is used for updating the data of the worklist 36. Preferably, the data of the actual worklist 36 is stored in a cache administrated by the workflow plug-in 12. If the user interacts with the workflow server 13 the cache will be updated.

Accordingly the invocation of status list 39 will cause status list process 29 to start and results in displaying status list 39.

It should be noted that in the context of instant messaging the contact data of communication partners can be administrated in so called buddy lists which contain the data of all possible communication partners of a user independent whether these users are currently logged in or not. However, the list of available users shown in FIGS. 4 and 5 includes only these users which are currently available. In the present example only six users out of nine possible users are available. The instant messaging client 10 is therefore able to retrieve information on the currently available users. This functionality is the so called awareness functionality of the instant messaging software 14.

In a modified embodiment the items of the worklist 15 and the status list 16 can also be selected on users or communication partners who are currently not available. In such an embodiment the contact form can be provided with a buddy list for administrating the contact date of all possible users. On selection of a specific item of the buddy list the worklist 15 or the status list 16 can be filtered accordingly and the result be displayed in the workflow form 35.

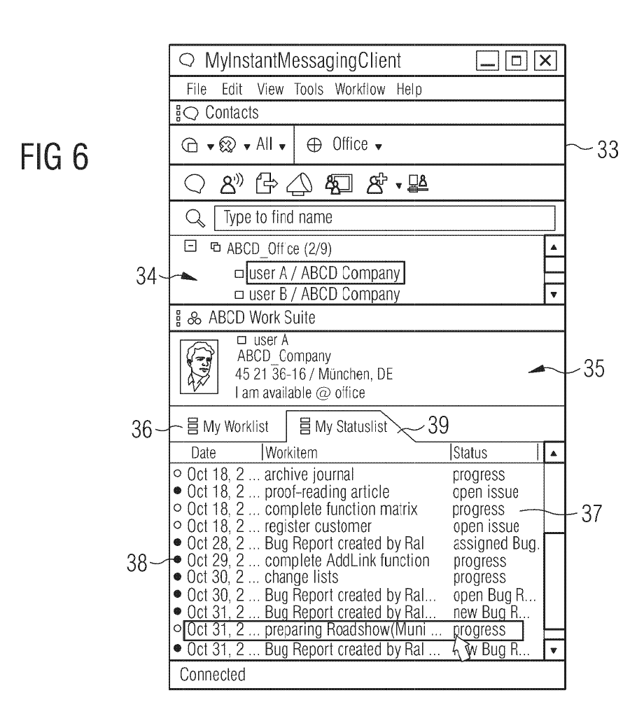

FIG. 6 shows a further view of the instant messaging form 33. According to FIG. 6 the contact form 34 has been diminished whereas the workflow form 35 has been expanded. It can be recognized from the instant messaging form 33 of FIG. 6, that user A has created a large number of work items 37, which have been delegated to other users. It may therefore be useful for user A to filter his status list 39 on a specific user.

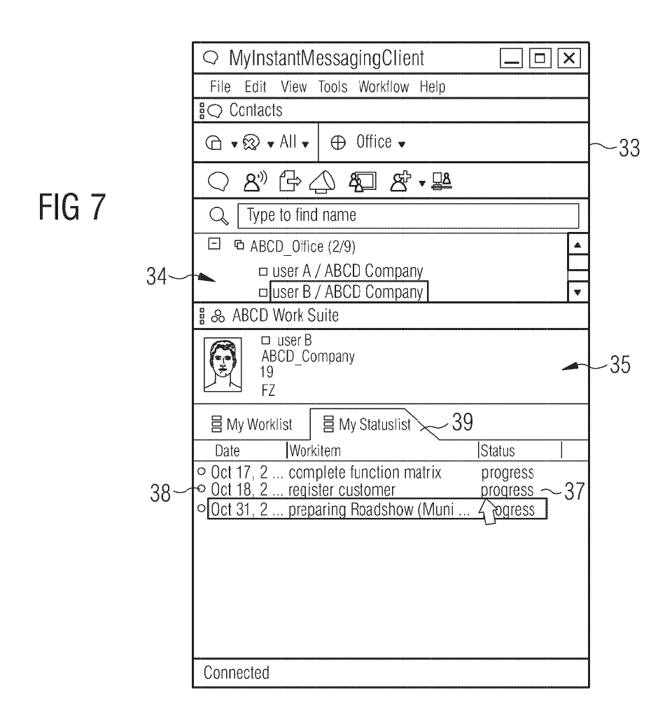

FIG. 7 shows the result of the filter operation. In FIG. 7 user A has selected user B within contact form 34, whereby status list 39 has been reduced to these work items 37, which has been delegated to user B. User A may now open one of the work items 37 delegated to user B.

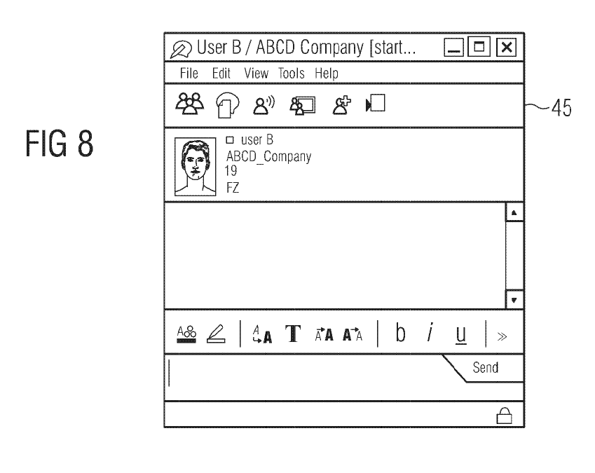

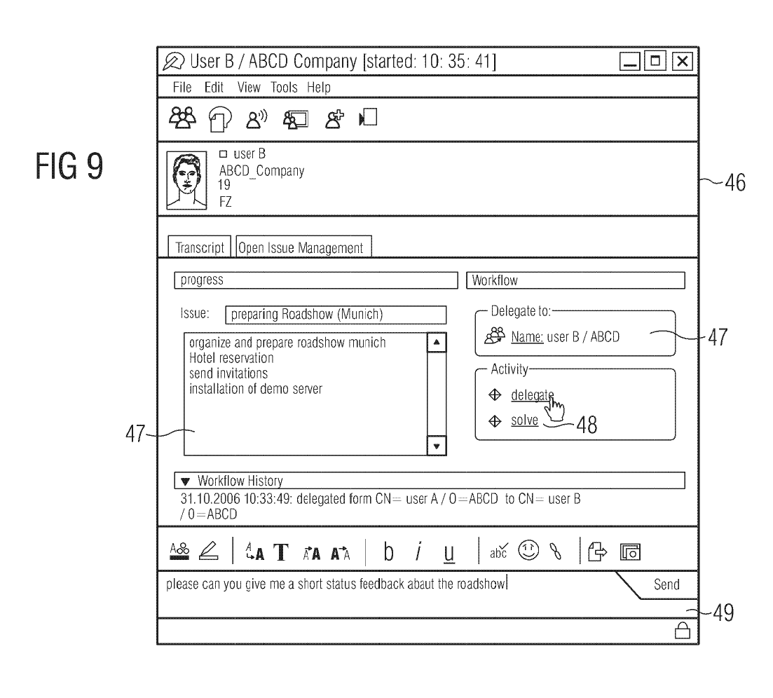

Referring back to FIG. 3, a work item invocation 40 starts a work item process 41. The work item process 41 sends a work item request 42 to workflow manager 18, which starts a work item process 43. Before termination the work item process 43 sends a work item response 44 back to work item process 41. If the work item process 41 does not retrieve any specific information with regard to the selected work item, a general instant messaging form 45 shown in FIG. 8 may be displayed on the monitor 8. However, if the work item process 41 results in specific data, which needs to be displayed, a work item form 46 as shown in FIG. 9 can be displayed on the monitor 8. The work item form 46 includes data fields 47 for displaying the data retrieved by the work item process 41 and a number of function fields 48 by which further processing can be initiated. For instance, the work item form 46 of FIG. 9 includes two data fields 47 for entering the issue and a comment. A third data field 47 indicates that the work item has been delegated to user B. Finally, two function fields 48 allow user A to “delegate” the process to another user or to “solve” the problem by further processing.

The work item form 46 can be derived from the instant messaging form 45. In particular, the classes of the work item form 46 may inherit attributes and methods from the instant messaging form 45. Accordingly the work item form 46 includes also an instant messaging subform 49 allowing instant messaging between user A and user B to whom the work item has been delegated.

Furthermore the data fields 47 and the function fields 48 may be adapted to exchange information with the web service of the workflow server 13. Therefore data may be retrieved from the workflow server 13 on opening the work item form 46 or may be transmitted to the workflow server 13 on closing the work item form 46 or on pressing a button for a storage operation.

Besides retrieving information on a special work item also new work items can be created. Referring back to FIG. 3 starting 50 of a work item 37 results in a handling process 51. If the work items 37 have not yet been created, a creation request 52 is sent to workflow manager 18 causing a creation process 53 to start on the workflow server 13. Before termination, the creation process 53 returns a creation response 54 back to the handling process 51. The creation response 54 may contain a confirmation of the creation of the work item or information on the created work items 37.

If the work item has already been created, a processing request 55 can be sent to the workflow manager 18, so that a handling process 56 will start on the workflow server 13. The results of the handling process 56 on the workflow server 13 will be returned to the handling process 51 by a handling response 57. The final results of handling process 51 can be displayed on monitor 8 to inform user A on the results of the processing of the started work item 37.

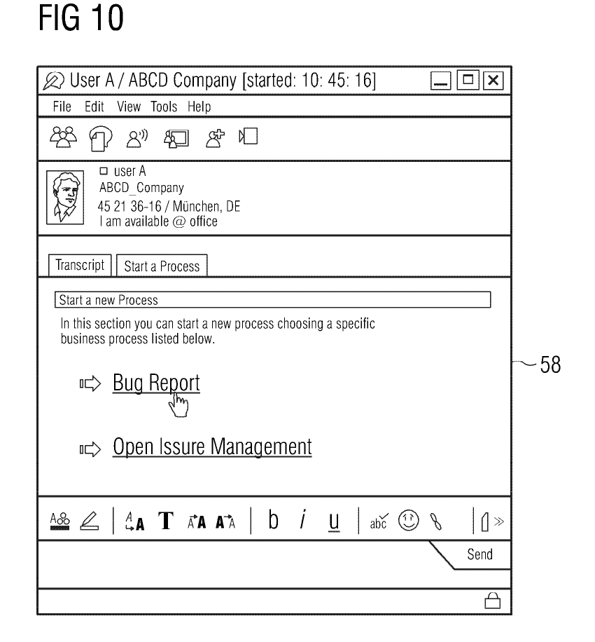

In FIG. 10 a typical handling form 58 for handling a work item 37 is shown. The handling form 58, which is also derived from the instant messaging form 45, comprises various additional buttons 59 for specific work processes to be started. The handling form 58 of FIG. 10 comprises especially a button “Bug Report” and another button “Open Issue Management” for starting a bug report process or to start another process for managing a open issue. Furthermore, the handling form 58 comprises also the instant messaging subform 49 of FIG. 9 for the exchange of instant messages with a selected instant messaging participant.

Referring back to FIG. 3, it should be noted that the workflow manager 18 can send a notification 60 to workflow plug-in 12 in case a new work item has been created for user A on the workflow server 13. The notification 60 uses the notification functionality of the instant messaging client 10 to create a notification process 61 for creating a message 62 for user A. The notification 60 may also cause an update of the worklist 15 or the status list 16, so that the instant messaging software 14 is also provided with a push service, whereby information on the workflow server 13 can be transported to the instant messaging client 10.

In addition it should be noted that the calls and requests of FIG. 3 are preferably performed asynchronously to prevent the instant messaging client 10 from blocking.

In the method described herein the workflow plug-in 12 uses the directory service 19 to identify the possible users or buddies by means of an unique user identification, which might also be used by the workflow server 13 to authenticate the user logged in into the instant messaging client 10 and invoking a worklist 15 or status list 16 or requiring the handling of a work item 37. The user identification is preferably extracted from a community session object using an application programming interface. An example for code extracting the user identification from a community session object is given in appendix A.

Since the work items 37 in the worklist 15 and in the status list 16 contain information on the users, who has created the work item 37 or to whom the work item has been delegated, the workflow plug-in 12 is able to compare the user information contained in the work item 37 with the awareness data of the instant messaging client 10. In consequence an association of the work items 37 to the instant messaging participants can be established and displayed. For these purposes the worklist 15 and the status list 16 are provided with a filter method, which automatically reduces the displayed work item 37 to the context of an instant messaging session. In particular, if instant messages are exchanged or if the user selects a buddy from his buddy list, the information on the communication partner or buddy will be used for executing the filter method for displaying the associated worklist 15 or status list 16. A code example for such a filter method is given in appendix B.

Further important components of the instant messaging software 14 are the work item forms 20 expanding the functionality of the instant work messaging client 10. These work item forms 20 allow displaying data associated with a work item 37 in an individual form. For these purposes instant messaging client 10 supports a mechanism to request a preferred work item form 20 for a specific work item 37. The information regarding the preferred work item form 20 forms a part of the workflow model residing on the workflow server 13. After connecting to workflow server 13, the information regarding the preferred work item form 20 may be cached in the workflow plug-in 12. Each time the user opens a work item 37 from his worklist 15 or status list 16, the workflow plug-in 12 fires an event to inform the instant messaging session to display the work item 37 in the preferred work item form 20. In case there is no information on a preferred work item form 20, the workflow plug-in 12 may open a general form as for example the general instant messaging form 45 of FIG. 8. A code example for retrieving the preferred work item form 20 is shown in appendix C.

The instant messaging client 10 is therefore able to manage the exchange of information on workflow issues under real time condition. The method therefore creates an effective working environment for collaboration over a distance. Another advantage of the method described herein is that the method can be adapted to any workflow model on any workflow server. Furthermore the method is not limited to a specific instant messaging software, but may be used in connection with any available instant messaging software. The following code examples, however are based on an instant messaging software product of IBM Corp. called SAMETIME.

### APPENDIX A

In the following code example an API of the instant messaging software 14 is used to extract the user identification from an instant messaging session object.

```
try {
  CommunityService communityMgr = (CommunityService) ServiceHub
          .getService(CommunityService.SERVICE_TYPE);
    RtcSession rs =communityMgr.getDefaultCommunity( ).-
    getRtcSession( );
    /**
    * If auto login - get user principal!
    */
    boolean bAutoLogin = ABCDworkPlugin.getPlugin( ).-
    getPreferenceStore( )
          .getBoolean(ABCDworkPlugin.COMMUNITY_LOGIN);
    if (bAutoLogin) {
      if (rs != null) {
        SigninInfo signin = rs.getSigninInfo( );
        ABCDworkPlugin.getPlugin( ).setPrincipal(signin.-
        getSigninName( ));
        }
      }
} catch (Exception e) {
    e.printStackTrace( );
}
```

### APPENDIX B

The following code example shows the implementation of a filter method for filtering the worklist 15 and the status list 16 inside an instant messaging client 10. In the code example the user ID of a currently selected buddy is used to filter the worklist 15 or the status list 16. The method will be called if the user changes the selected available user in the list of available users.

```
private void refreshPersonInfo(final Person person) {
    // start new thread
  bizCard.getDisplay( ).asyncExec(new Runnable( ) {
      public void run( ) {
        bizCard.setPerson(person);
        // local person selected?
        if (person.getContactId( ).equals(getLocalBuddy( ).-
        getContactId( ))) {
          // reset filter
          workListView.setBuddyFilter(null,true);
          statusListView.setBuddyFilter(null,false);
        } else {
          // display filtered lists on graphical user interface
          workListView.setBuddyFilter(person.getContactId( ),true);
          statusListView.setBuddyFilter(person.getContactId( ),false );
        }
      }
  });
}
```

### APPENDIX C

The following code is an example of a method for determining the preferred ChatAreaID from the $processID inside the work item 37. In the method a cache is checked and after that the form ID is directly requested from the web service provided by the workflow server 13.

```
Public String getChatAreaID(WorkItem aWorkItem) {
  String sGroup = null;
  String sChatAreaID = null;
  if (aWorkItem == null)
    return ABCDworkPlugin.-
    DEFAULTWORKITEM_CHATAREA_ID;
  try {
    int aProcessID = aWorkItem.getItemCollection( ).-
    getItemValueInteger(
        “$ProcessID”);
    // first check cache
    sChatAreaID = (String) chatAreaIDCache.-
    get(new Integer(aProcessID));
    if (sChatAreaID != null) {
      return sChatAreaID;
    }
    // request ProcessEntity from model proxy
    Iterator iter = modelServiceProxy.getProcessList( ).iterator( );
    while (iter.hasNext( )) {
      HashMap map = (HashMap) iter.next( );
      ItemCollection itmCol = new ItemCollection(map);
      if (aProcessID == itmCol.getItemValueInteger(“numProcessID”)) {
        sGroup = itmCol.getItemValueString(“txtWorkflowGroup”);
        break;
      }
    }
    if (sGroup != null) {
      String sFormAttribute = “sametime.form.” + sGroup;
      iter = modelServiceProxy.getEnvironmentList( ).iterator( );
    while (iter.hasNext( )) {
      HashMap map = (HashMap) iter.next( );
      ItemCollection itmCol = new ItemCollection(map);
      if (“environment.ABCDsametime”.equals(itmCol
          .getItemValueString(“txtName”))) {
        // add chatarea to cache
        sChatAreaID = itmCol.getItemValueString(sFormAttribute);
      // check if a chatarea is defined
        if (“”.equals(sChatAreaID))
          ChatAreaID =
          ABCDworkPlugin.-
          DEFAULTWORKITEM_CHATAREA_ID;
        chatAreaIDCache.put(new Integer(aProcessID),
              sChatAreaID);
          return sChatAreaID;
          // break;
        }
      }
    }
  } catch (Exception e) { }
  // Return default Value
  return ABCDworkPlugin.DEFAULTWORKITEM_CHATAREA_ID;
}
```

What is claimed is:

1. A method for communication and collaboration over a network, in which instant messages are exchanged between an instant messaging server and an instant messaging client and in which workflow data provided by a workflow server are processed by the instant messaging client, wherein user data identifying a specific user of the instant messaging client is used to retrieve workflow process data associated with the specific user from the workflow server and wherein the association between user data and workflow process data is displayed on a user interface.

2. The method according to claim 1, wherein a user identification is requested from a directory service by the instant messaging client after the specific user has logged into the instant messaging client.

3. The method according to claim 2, wherein a set of workflow data associated with the user identification is requested from a workflow server by the instant messaging client.

4. The method according to claim 3, wherein the workflow data is cached into the instant messaging client and updated periodically.

5. The method according to claim 1, wherein a set of available users is requested from an instant messaging server by the instant messaging client.

6. The method according to claim 5, wherein the set of available users is cached in the instant messaging client and periodically updated.

7. The method according to claim 2, wherein a status list of workflow processes created by the specific user and assigned to other users is generated from the workflow process data associated with the specific user and is displayed on the user interface.

8. The method according to claim 2, wherein a task list of workflow processes created by the specific user and assigned to other users is generated from the workflow process data associated with the specific user and is displayed on the user interface.

9. The method according to claim 7, wherein the availability of the other users is indicated by indicators associated with each list item.

10. The method according to claim 5, wherein on selection of a selected user among the set of available users a user identification of the selected user is requested from a directory service by the instant messaging client.

11. The method according to claim 10, wherein a status list of workflow processes created by the specific user and assigned to the selected user is generated from the workflow process data associated with the specific user and is displayed on the user interface.

12. The method according to claim 10, wherein a task list of workflow processes created by the selected user and assigned to the specific user is generated from the workflow process data associated with the specific user and is displayed on the user interface.

13. The method according to claim 11, wherein the workflow process data is filtered on the specific user and the selected user.

14. The method according to claim 1, wherein on opening a workflow item of the workflow process data a form identification is retrieved from the workflow server and a workflow form associated with the form identification and containing the workflow process data of the selected workflow item is displayed on the user interface.

15. The method according to claim 14, wherein workflow process data is transmitted from the workflow form to the workflow server.

16. The method according to claim 1, wherein the workflow server provides a web service for retrieving workflow process data from the workflow server.

17. An instant messaging client for communication and collaboration over a network comprising:
program code for exchanging instant messages with an instant messaging server;
program code for processing workflow data provided by a workflow server; and
program code for retrieving user data identifying a specific user of the instant messaging client, for retrieving workflow process data associated with the specific user from the workflow server and for displaying the association between user data and workflow process data on a user interface.

18. A plug-in for an instant messaging client comprising program code arranged for retrieving user data identifying a specific user of the instant messaging client, for retrieving workflow process data from a workflow server and for displaying the association between user data and workflow process data on a user interface.
